(19) United States
(12) Patent Application Publication
(10) Pub. No.: US 2025/0240667 A1
(43) Pub. Date: Jul. 24, 2025

(54) SYSTEMS AND METHODS FOR IMPLEMENTING INTRA-USER FLOW DIFFERENTIATION FOR DATA FLOWS RUNNING ON A USER EQUIPMENT

(71) Applicant: Verizon Patent and Licensing Inc., Basking Ridge, NJ (US)

(72) Inventors: Ratul K. GUHA, Warwick, PA (US); Zainab ABABRI, Dallas, TX (US)

(73) Assignee: Verizon Patent and Licensing Inc., Basking Ridge, NJ (US)

(21) Appl. No.: 18/420,256

(22) Filed: Jan. 23, 2024

(51) Int. Cl. H04W 28/02; H04L 43/0882; H04W 48/18

(52) U.S. Cl. CPC H04W 28/0268; H04L 43/0882; H04W 48/18

(57) ABSTRACT

In some implementations, a network node a radio access network (RAN) may receive, from a user equipment (UE), an indication of a traffic descriptor associated with an application running on the UE. The network node may allocate, using a RAN scheduling function associated with the network node, resources for the application based on an intra-user flow priority, wherein different applications associated with the UE are allocated with different amounts of resources based on the intra-user flow priority.

### BACKGROUND

Wireless communication systems are widely deployed to provide various telecommunication services such as telephony, video, data, messaging, and broadcasts. A wireless network may include one or more network nodes that support communication for wireless communication devices.

### BRIEF DESCRIPTION OF THE DRAWINGS

FIG. 1 is a diagram of an example associated with implementing intra-user flow differentiation for data flows running on a user equipment (UE).

FIG. 2 is a diagram of an example associated with different logical flows for different classes of applications.

FIG. 3 is a diagram of an example associated with a hierarchy of traffic quality of service (QoS) between users and within users.

FIG. 4 is a diagram of an example environment in which systems and/or methods described herein may be implemented.

FIG. 5 is a diagram of example components of one or more devices of FIG. 4.

FIG. 6 is a flowchart of an example process associated with implementing intra-user flow differentiation for data flows running on a UE.

### DETAILED DESCRIPTION OF EXAMPLE EMBODIMENTS

The following detailed description of example implementations refers to the accompanying drawings. The same reference numbers in different drawings may identify the same or similar elements.

A QoS class identifier (QCI) may be a mechanism to ensure that traffic is allocated with appropriate QoS. Different traffic may require different QoS, and thus may be associated with different QCI values. For example, a QCI value may range from 1 to 9, where a lower QCI value may indicate higher priority and stricter quality requirements, whereas a higher QCI value may indicate lower priority and more relaxed quality requirements. A high priority class may draw resources from other users in a cell, such that priority may impact one user relative to another user. The QCI may be useful for inter-user priority (e.g., priority between different users). Latency under load may be impacted by a cell load, as well as all other traffic generated by a user opting in for low latency. To reduce latency, inter-user approaches may be less effective due to tradeoffs to other users in the cell.

For a given user, certain classes of traffic or network slices may need to be prioritized in a wireless network. The classes of traffic or network slices may need better performance under load. However, all classes may receive the same treatment when the classes are associated with the same QoS class. For example, low latency traffic and gaming traffic may receive the same treatment when the low latency traffic and the gaming traffic are associated with the same QoS class, which may result in equal intra-user priority. In other words, for the given user, different applications may be treated with the same priority, even though traffic for one application may be more latency-sensitive than traffic for another application. As a result, an overall performance of a UE that runs multiple applications may be degraded because data for relatively sensitive applications and use cases may not be differentiated relative to other applications.

In some implementations, for a given user, applications may be classified into groups of traffic classes (or categories) and network slices. For each class, a network node may assign a separate logical flow using network slicing and UE route selection policy (URSP) information. The network node may create a prioritization that shifts resources within the classes for the given user, without impacting other users in a cell, which may be different than assigning priority across user classes. In other words, priority for different classes of applications based on intra-user flow priority may not be based on relative priority between users. An unequal intra-user priority may be achieved, such that different classes of applications for the same user may be assigned with different priority levels. Further, a cell-level load may be used as a trigger for the prioritization.

In some implementations, by implementing intra-user flow priority (or intra-user flow differentiation) in a radio access network (RAN) for low latency with network slicing, different classes of applications (or different use cases) may be assigned with separate logical flows using network slicing and URSP information, thereby achieving unequal intra-user priority. For example, for a given user, latency sensitive traffic types may be prioritized over background file downloads. As a result, an overall performance of a UE that runs multiple applications may be improved because data for relatively sensitive applications and use cases may be differentiated relative to other applications.

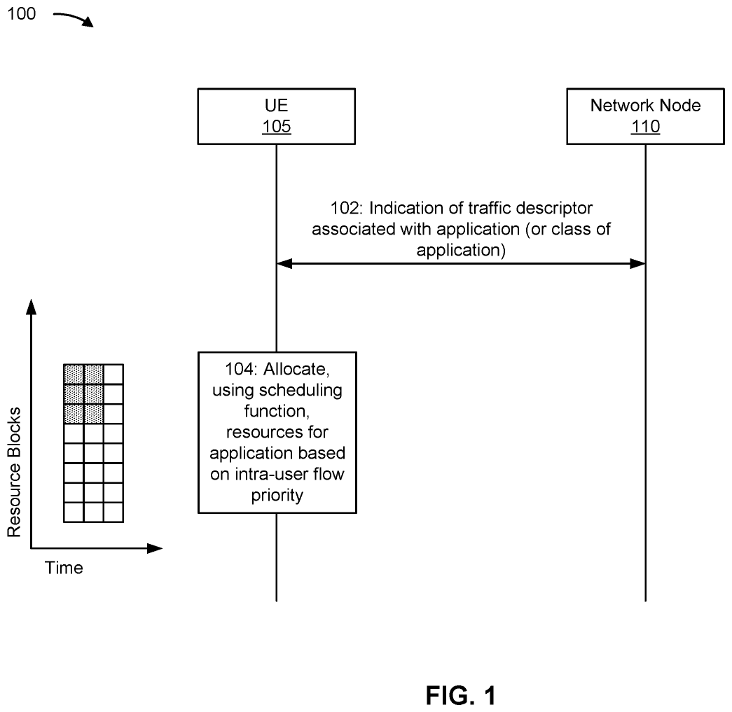

FIG. 1 is a diagram of an example 100 associated with implementing intra-user flow differentiation for data flows running on a UE. As shown in FIG. 1, example 100 includes a UE 105 and a network node 110 (e.g., a gNB). The network node 110 may be included in a RAN.

As shown by reference number 102, the network node 110 may receive, from the UE 105, an indication of a traffic descriptor associated with an application running on the UE 105. Alternatively, the traffic descriptor may be associated with a class of application, where the application running on the UE 105 may be associated with the class of application. For example, the application (or class of application) may be associated with low latency traffic. Further, each class may be assigned to a separate logical flow using network slicing and a URSP.

As shown by reference number 104, the network node 110 may allocate, using a RAN scheduling function associated with the network node 110, resources for the application based on an intra-user flow priority. The resources may be time and/or frequency resources. Different applications or use cases associated with the UE 105 may be allocated with different amounts of resources based on the intra-user flow priority. The intra-user flow priority may be based on a QCI (or a Fifth Generation (5G) QoS identifier (5QI) and single network slice selection assistance information (S-NSSAI). The intra-user flow priority may be triggered based on network measurements, where the network measurements may be associated with a cell-level load. The network node 110 may select the resources for the application from a set of resource blocks allocated for the UE 105 based on an inter-user flow priority. The UE 105 may perform a transmission to the network node 110 using allocated resources.

In some implementations, for a given user, the network node 110 may classify applications (or devices on a customer premises equipment (CPE)) into groups of traffic classes (or categories) and network slices. For each class, the network node 110 may assign a separate logical flow using network slicing and a URSP. Each logical flow may be associated with a network slice and/or a QoS flow, where the network slice and/or the QoS flow may be defined by the URSP. The network node 110 may create a prioritization that shifts resources within the classes for the given user, without impacting other users in a cell, which may be different than assigning priority across user classes. An unequal intra-user priority may be achieved, such that different classes of applications for the same user may be assigned with different priority levels.

In some implementations, based on the intra-user flow priority in the RAN for low latency with network slicing, different classes of applications may be assigned with separate logical flows using network slicing and URSP information, thereby achieving unequal intra-user priority. One flow may be associated with one network slice and another flow may be associated with another network slice. The network node 110 may set up separate flows for different classes of applications of the UE 105, where the separate flows may each be associated with a given priority. For example, for a given user, latency sensitive traffic types may be prioritized over background file downloads. As a result, an overall performance of the UE 105 that runs multiple applications may be improved because relatively important applications may be prioritized over less important applications.

In some implementations, a flow separation or priority may run by default (e.g., the network node 110 may always apply the flow separation or priority within the same user). Alternatively, a cell-level load may be used as a trigger for the prioritization. The flow separation or priority may be triggered based on the network measurements. A trigger for the intra-user flow priority may be RAN metrics and/or transport metrics for a congestion level (e.g., level 1, level 2, or level 3). The trigger may depend on RAN levels of congestion. The trigger may be based on various RAN-based measurements, such as user speed estimation volume, connection count, and/or latency. Additionally, or alternatively, the trigger may be based on various transport-based measurements, such as total throughput, frame delay, and/or frame loss. When certain metrics are exceeded, certain classes of applications may be prioritized over other classes of applications. In some implementations, depending on the cell-level load (e.g., a certain metric satisfies a threshold), the network node 110 may create separate classes of applications and assign separate logical flows to each class using network slicing and the URSP, or alternatively, the network node 110 may always implement the separate logical flows, regardless of the cell-level load.

In some implementations, the network node 110, via the RAN scheduling function, may first run an inter-user priority scheduling function, which may be followed by an intra-user priority scheduling function. For the inter-user priority scheduling function, a proportional fair function is commonly used where, J physical resource blocks (PRBs) may be defined. In a transmission time interval (TTI), the network node 110 may select user i for resource block (RB) j€ {1 . . . J} based on a maximum value of mᵢⱼ, where mᵢⱼ=Wᵢ*rᵢⱼ/(rᵢ^{avg}+Σ^{J}ⱼ₌₁αᵢⱼrᵢⱼ). Here, rᵢⱼ is a throughput for user i on RB j (function of signal-to-interference-plus-noise ratio (SINR) and modulation and coding scheme (MCS)), and rᵢ^{avg} is a past average for user i. Further, αᵢⱼ is 1 when a j^{th} RB is already assigned to user i, otherwise 0. Further, Wᵢ is a relative priority for user i. For the intra-user priority scheduling function, within priority classes C for user i, a low-latency class L, and a general traffic class G for user i with low-latency service, user i may have a PRB set P in a TTI set T. The PRB set P (e.g., 7, 19, 23, . . . ) may be derived from an inter-user priority. For every TTI in set T, the network node 110 may select flow L for RB j€P based on a maximum value of m_{L}, where m_{L}=W_{L}*(B_{L}). Here, B_{L} is an average waiting time for packets in queue L, and W_{L} is a relative intra-user priority for low-latency class L (e.g., W_{L}=2*W_{G}).

In some implementations, during the inter-user priority scheduling function, the network node 110, via the RAN scheduling function, may allocate resources between users. After the network node 110 determines the allocation of resources across users, the network node 110 may determine the amount of resources to allocate to each flow within a certain user. In other words, for the same user, the network node 110 may allocate certain amounts of resources to different flows, depending on the priority of each flow. The priority may be tied to latency sensitivity of different use cases and/or applications. For example, a flow associated with low latency may be allocated with more resources than a flow associated with social media.

As indicated above, FIG. 1 is provided as an example. Other examples may differ from what is described with regard to FIG. 1. The number and arrangement of devices shown in FIG. 1 are provided as an example. In practice, there may be additional devices, fewer devices, different devices, or differently arranged devices than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) shown in FIG. 1 may perform one or more functions described as being performed by another set of devices shown in FIG. 1.

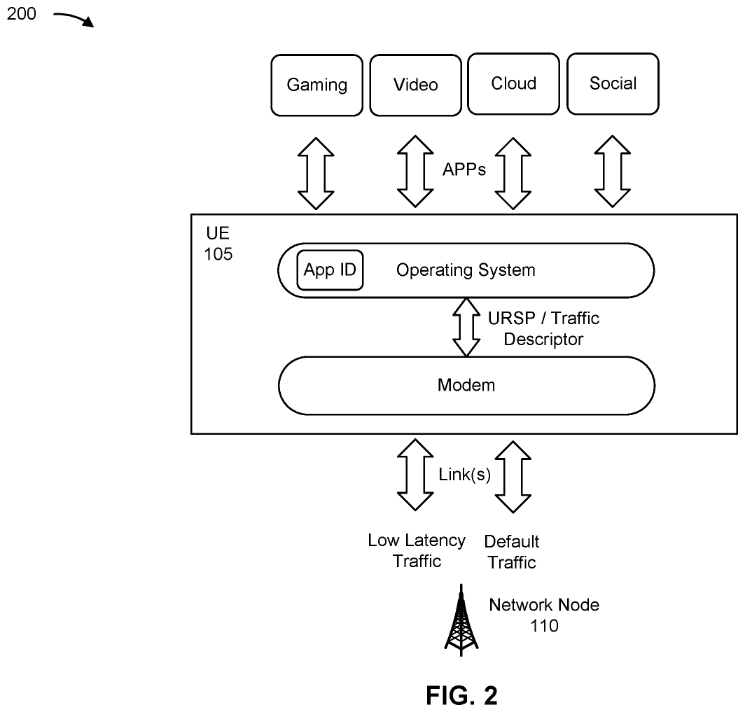

FIG. 2 is a diagram of an example 200 associated with different logical flows for different classes of applications. As shown in FIG. 2, example 200 includes a UE 105 and a network node 110 (e.g., a gNB).

In some implementations, for a given user, separate classes may be created using a URSP, and network slicing may be used to differentiate traffic. The UE 105 (or a CPE) may be associated with various applications, which may relate to gaming, video, cloud, and/or social. Separate classes may be created for gaming, video, cloud, and/or social using the URSP. Each application may be associated with an application identifier. The application identifier may be based on a traffic class (or category). The UE 105 may run an operating system. The UE 105 may indicate, via a modem of the UE 105, a traffic descriptor (or URSP information) to the network node 110. The network node 110 may set up different links for different types of traffic. For example, the network node 110 may set up a link for low latency traffic and a link for general traffic. The network node 110 may allocate separate flows for low latency traffic and general traffic. A RAN scheduler of the network node 110 may implement intra-user priority based on a 5QI and S-NSSAI. The low latency traffic may be prioritized over the general traffic. For example, the low latency traffic may be associated with gaming, whereas the general traffic may be associated with video, cloud, and social. As a result, by creating separate classes and prioritizing some classes over other classes, an overall performance of the UE 105 may be improved.

As indicated above, FIG. 2 is provided as an example. Other examples may differ from what is described with regard to FIG. 2. The number and arrangement of devices shown in FIG. 2 are provided as an example. In practice, there may be additional devices, fewer devices, different devices, or differently arranged devices than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) shown in FIG. 2 may perform one or more functions described as being performed by another set of devices shown in FIG. 2.

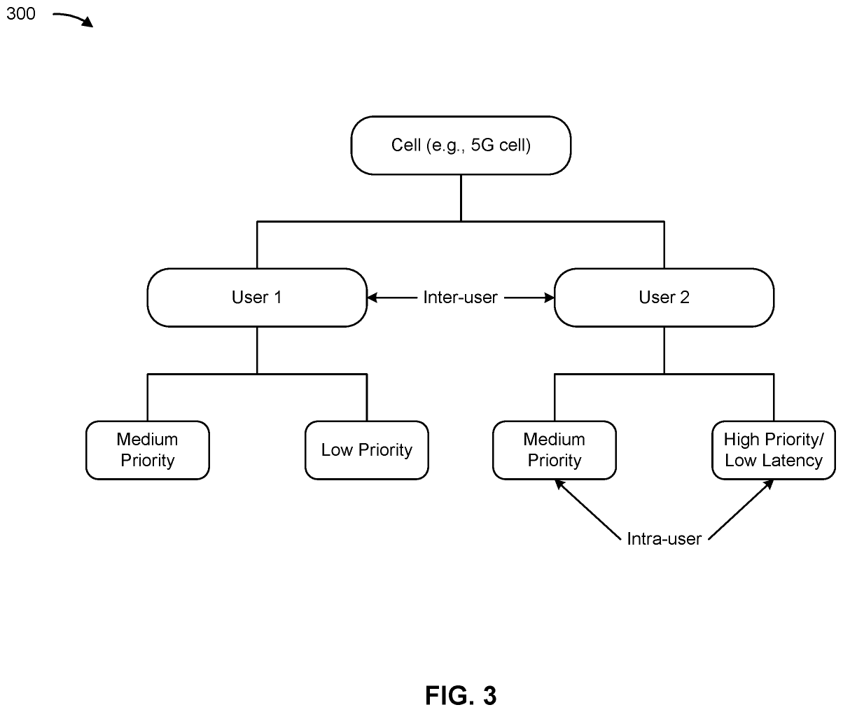

FIG. 3 is a diagram of an example 300 associated with a hierarchy of traffic QoS between users and within users.

As shown in FIG. 3, a hierarchical traffic QoS may be implemented. The hierarchical traffic QoS may be enabled between users and within the same user. The hierarchical traffic QoS may be based on a first level and a second level. The first level may correspond to an inter-user flow priority. Within a cell (e.g., a 5G cell), a first user and a second user may be prioritized based on the inter-user flow priority. The second level may correspond to the intra-user flow priority. For example, for the second user, applications with medium priority and high priority (low latency) may be prioritized based on the intra-user flow priority.

As indicated above, FIG. 3 is provided as an example. Other examples may differ from what is described with regard to FIG. 3.

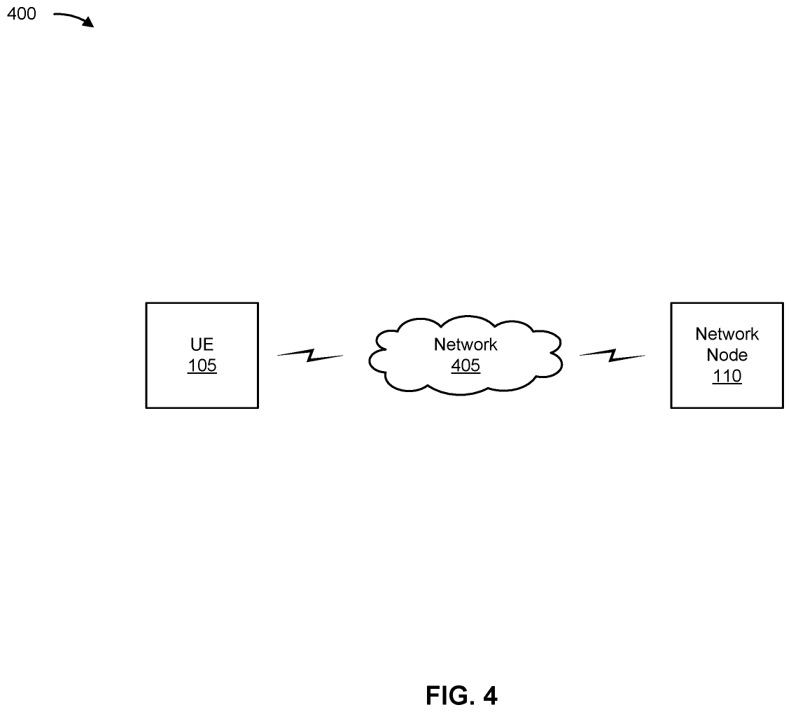

FIG. 4 is a diagram of an example environment 400 in which systems and/or methods described herein may be implemented. As shown in FIG. 4, environment 400 may include a UE 105, a network node 110, and a network 405. Devices of environment 400 may interconnect via wired connections, wireless connections, or a combination of wired and wireless connections.

The UE 105 may include one or more devices capable of receiving, generating, storing, processing, and/or providing information associated with implementing intra-user flow differentiation for data flows running on the UE 105, as described elsewhere herein. The UE 105 may include a communication device and/or a computing device. For example, the UE 105 may include a wireless communication device, a mobile phone, CPE, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), a smart television, an IoT device, or a similar type of device.

The network node 110 may include one or more devices capable of receiving, processing, storing, routing, and/or providing information associated with implementing intra-user flow differentiation for data flows running on the UE 105, as described elsewhere herein. The network node 110 may be configured to communicate with the UE 105. The network node 110 may be an aggregated network node, meaning that the aggregated network node is configured to utilize a radio protocol stack that is physically or logically integrated within a single RAN node (e.g., within a single device or unit). The network node 110 may be a disaggregated network node (sometimes referred to as a disaggregated base station), meaning that the network node 430 is configured to utilize a protocol stack that is physically or logically distributed among two or more nodes (such as one or more central units (CUs), one or more distributed units (DUs), or one or more radio units (RUs)). The network node 110 may include, for example, a New Radio (NR) base station, a long-term evolution (LTE) base station, a Node B, an eNB (e.g., in 4G), a gNB (e.g., in 5G), an access point, a transmission reception point (TRP), a DU, an RU, a CU, a mobility element of a network, a core network node, a network element, a network equipment, and/or a RAN node.

The network 405 may include one or more wired and/or wireless networks. For example, the network 405 may include a cellular network (e.g., a 5G network, a fourth generation (4G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks. The network 405 enables communication among the devices of environment 400.

The number and arrangement of devices and networks shown in FIG. 4 are provided as an example. In practice, there may be additional devices and/or networks, fewer devices and/or networks, different devices and/or networks, or differently arranged devices and/or networks than those shown in FIG. 4. Furthermore, two or more devices shown in FIG. 4 may be implemented within a single device, or a single device shown in FIG. 4 may be implemented as multiple, distributed devices. Additionally, or alternatively, a set of devices (e.g., one or more devices) of environment 400 may perform one or more functions described as being performed by another set of devices of environment 400.

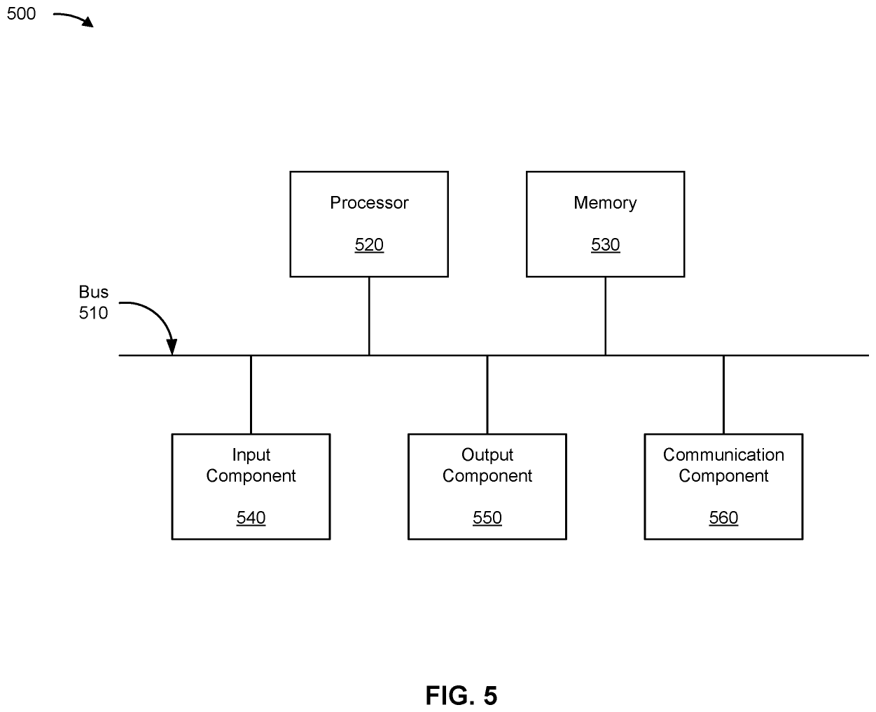

FIG. 5 is a diagram of example components of a device 500 associated with implementing intra-user flow differentiation for data flows running on a UE. The device 500 may correspond to network node 110. In some implementations, the network node 110 may include one or more devices 500 and/or one or more components of the device 500. As shown in FIG. 5, the device 500 may include a bus 510, a processor 520, a memory 530, an input component 540, an output component 550, and/or a communication component 560.

The bus 510 may include one or more components that enable wired and/or wireless communication among the components of the device 500. The bus 510 may couple together two or more components of FIG. 5, such as via operative coupling, communicative coupling, electronic coupling, and/or electric coupling. For example, the bus 510 may include an electrical connection (e.g., a wire, a trace, and/or a lead) and/or a wireless bus. The processor 520 may include a central processing unit, a graphics processing unit, a microprocessor, a controller, a microcontroller, a digital signal processor, a field-programmable gate array, an application-specific integrated circuit, and/or another type of processing component. The processor 520 may be implemented in hardware, firmware, or a combination of hardware and software. In some implementations, the processor 520 may include one or more processors capable of being programmed to perform one or more operations or processes described elsewhere herein.

The memory 530 may include volatile and/or nonvolatile memory. For example, the memory 530 may include random access memory (RAM), read only memory (ROM), a hard disk drive, and/or another type of memory (e.g., a flash memory, a magnetic memory, and/or an optical memory). The memory 530 may include internal memory (e.g., RAM, ROM, or a hard disk drive) and/or removable memory (e.g., removable via a universal serial bus connection). The memory 530 may be a non-transitory computer-readable medium. The memory 530 may store information, one or more instructions, and/or software (e.g., one or more software applications) related to the operation of the device 500. In some implementations, the memory 530 may include one or more memories that are coupled (e.g., communicatively coupled) to one or more processors (e.g., processor 520), such as via the bus 510. Communicative coupling between a processor 520 and a memory 530 may enable the processor 520 to read and/or process information stored in the memory 530 and/or to store information in the memory 530.

The input component 540 may enable the device 500 to receive input, such as user input and/or sensed input. For example, the input component 540 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 550 may enable the device 500 to provide output, such as via a display, a speaker, and/or a light-emitting diode. The communication component 560 may enable the device 500 to communicate with other devices via a wired connection and/or a wireless connection. For example, the communication component 560 may include a receiver, a transmitter, a transceiver, a modem, a network interface card, and/or an antenna.

The device 500 may perform one or more operations or processes described herein. For example, a non-transitory computer-readable medium (e.g., memory 530) may store a set of instructions (e.g., one or more instructions or code) for execution by the processor 520. The processor 520 may execute the set of instructions to perform one or more operations or processes described herein. In some implementations, execution of the set of instructions, by one or more processors 520, causes the one or more processors 520 and/or the device 500 to perform one or more operations or processes described herein. In some implementations, hardwired circuitry may be used instead of or in combination with the instructions to perform one or more operations or processes described herein. Additionally, or alternatively, the processor 520 may be configured to perform one or more operations or processes described herein. Thus, implementations described herein are not limited to any specific combination of hardware circuitry and software.

The number and arrangement of components shown in FIG. 5 are provided as an example. The device 500 may include additional components, fewer components, different components, or differently arranged components than those shown in FIG. 5. Additionally, or alternatively, a set of components (e.g., one or more components) of the device 500 may perform one or more functions described as being performed by another set of components of the device 500.

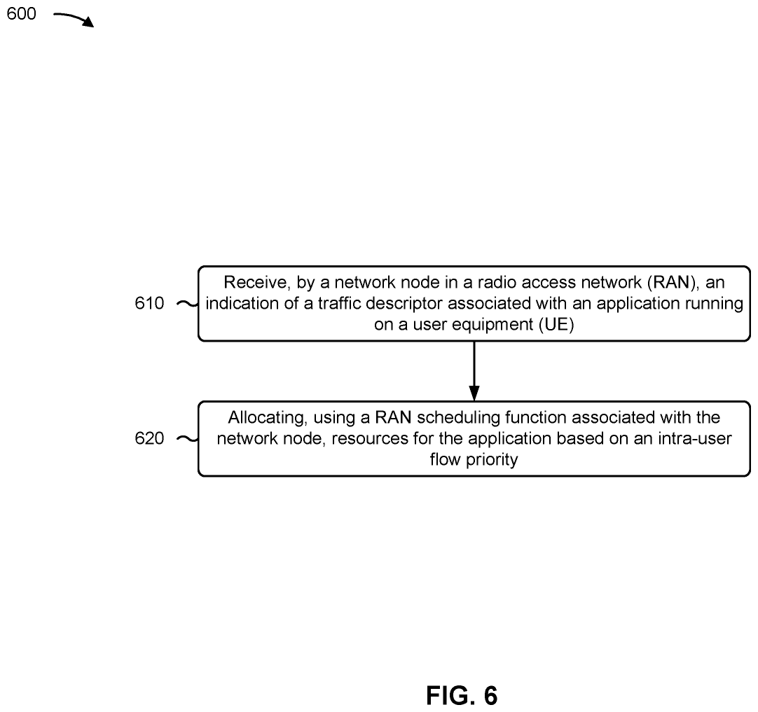

FIG. 6 is a flowchart of an example process 600 associated with implementing intra-user flow differentiation for data flows running on a UE. In some implementations, one or more process blocks of FIG. 6 may be performed by a network node (e.g., network node 110). In some implementations, one or more process blocks of FIG. 6 may be performed by another device or a group of devices separate from or including the network node, such as a UE (e.g., UE 105). Additionally, or alternatively, one or more process blocks of FIG. 6 may be performed by one or more components of device 500, such as processor 520, memory 530, input component 540, output component 550, and/or communication component 560.

As shown in FIG. 6, process 600 may include receiving, by the network node in a RAN and from a UE, an indication of a traffic descriptor associated with an application running on the UE (block 610). Alternatively, the traffic descriptor may be associated with a class of application, where the application running on the UE may be associated with the class of application. For example, the application (or class of application) may be associated with low latency traffic. Further, each class may be assigned to a separate logical flow using network slicing and a URSP.

As shown in FIG. 6, process 600 may include allocating, using a RAN scheduling function associated with the network node, resources for the application based on an intra-user flow priority, wherein different applications or use cases associated with the UE are allocated with different amounts of resources based on the intra-user flow priority (block 620). The intra-user flow priority may be based on a 5QI and S-NSSAI. The intra-user flow priority may be triggered based on network measurements, where the network measurements may be associated with a cell-level load. The network node may select the resources for the application from a set of resource blocks allocated for the UE based on an inter-user flow priority. In some implementations, the network node may implement a hierarchical traffic QoS. The hierarchical traffic QoS may be based on a first level and a second level. The first level may correspond to an inter-user flow priority. The second level may correspond to the intra-user flow priority.

Although FIG. 6 shows example blocks of process 600, in some implementations, process 600 may include additional blocks, fewer blocks, different blocks, or differently arranged blocks than those depicted in FIG. 6. Additionally, or alternatively, two or more of the blocks of process 600 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a network node in a radio access network (RAN), an indication of a traffic descriptor associated with an application running on a user equipment (UE); and
allocating, using a RAN scheduling function associated with the network node, resources for the application based on an intra-user flow priority, wherein different applications associated with the UE are allocated with different amounts of resources based on the intra-user flow priority.

2. The method of claim 1, wherein the intra-user flow priority is based on a Fifth Generation (5G) quality of service (QoS) identifier (5QI) and single network slice selection assistance information (S-NSSAI).

3. The method of claim 1, wherein the application is associated with a class of applications, and each class is assigned to a separate logical flow using network slicing and a UE route selection policy (URSP).

4. The method of claim 1, further comprising a hierarchical traffic quality of service (QoS) based on a first level and a second level, the first level corresponds to an inter-user flow priority, and the second level corresponds to the intra-user flow priority.

5. The method of claim 1, wherein the resources for the application are selected from a set of resource blocks allocated for the UE based on an inter-user flow priority.

6. The method of claim 1, wherein the intra-user flow priority is triggered based on network measurements, and the network measurements are associated with a cell-level load.

7. The method of claim 1, wherein the application is associated with low latency traffic.

8. A device, comprising:
one or more processors configured to:
receive an indication of a traffic descriptor associated with an application running on a user equipment (UE); and
allocate, using a scheduling function, resources for the application based on an intra-user flow priority, wherein different applications associated with the UE are allocated with different amounts of resources based on the intra-user flow priority.

9. The device of claim 8, wherein the intra-user flow priority is based on a Fifth Generation (5G) quality of service (QoS) identifier (5QI) and single network slice selection assistance information (S-NSSAI).

10. The device of claim 8, wherein the application is associated with a class of applications, and each class is assigned to a separate logical flow using network slicing and a UE route selection policy (URSP).

11. The device of claim 8, wherein the device is associated with a hierarchical traffic quality of service (QoS) based on a first level and a second level, the first level corresponds to an inter-user flow priority, and the second level corresponds to the intra-user flow priority.

12. The device of claim 8, wherein the one or more processors are configured to select the resources for the application from a set of resource blocks allocated for the UE based on an inter-user flow priority.

13. The device of claim 8, wherein the intra-user flow priority is triggered based on network measurements, and the network measurements are associated with a cell-level load.

14. The device of claim 8, wherein the application is associated with low latency traffic.

15. A non-transitory computer-readable medium storing a set of instructions, the set of instructions comprising:
one or more instructions that, when executed by one or more processors of a device, cause the device to:
receive an indication of a traffic descriptor associated with an application running on a user equipment (UE); and
allocate, using a scheduling function, resources for the application based on an intra-user flow priority, wherein different applications associated with the UE are allocated with different amounts of resources based on the intra-user flow priority.

16. The non-transitory computer-readable medium of claim 15, wherein the intra-user flow priority is based on a Fifth Generation (5G) quality of service (QoS) identifier (5QI) and single network slice selection assistance information (S-NSSAI).

17. The non-transitory computer-readable medium of claim 15, wherein the application is associated with a class of applications, and each class is assigned to a separate logical flow using network slicing and a UE route selection policy (URSP).

18. The non-transitory computer-readable medium of claim 15, wherein the device is associated with a hierarchical traffic quality of service (QoS) based on a first level and a second level, the first level corresponds to an inter-user flow priority, and the second level corresponds to the intra-user flow priority.

19. The non-transitory computer-readable medium of claim 15, wherein the resources for the application are selected from a set of resource blocks allocated for the UE based on an inter-user flow priority.

20. The non-transitory computer-readable medium of claim 15, wherein the intra-user flow priority is triggered based on network measurements, and the network measurements are associated with a cell-level load.
